(19) United States
(12) Patent Application Publication
(10) Pub. No.: US 2022/0179942 A1
(43) Pub. Date: Jun. 9, 2022

(54) SYSTEM AND METHOD FOR FACILITATING COMPLIANCE WITH EVOLVING STANDARDS AND REAL TIME CONDITIONS

(71) Applicant: Reprivata LLC, Palo Alto, CA (US)

(72) Inventors: Massoud Rad, Sugar Land, TX (US); Francis Scott Yeager, Liano, TX (US)

(73) Assignee: Reprivata LLC, Palo Alto, CA (US)

(21) Appl. No.: 17/111,090

(22) Filed: Dec. 3, 2020

(51) Int. Cl. G06F 21/45; G06Q 30/00

(52) U.S. Cl. CPC G06F 21/45; G06Q 30/018

(57) ABSTRACT

A method of certifying compliance with a protocol to generate a verifiable and secure credential to access a trusted network includes selecting a first protocol for which certification is requested on behalf of an entity; generating a set of compliance questions for the first protocol corresponding to elements of at least one protocol including the first protocol; identifying protocols other than the first protocol with which the user is currently certified; mapping elements of the other protocols with elements of the first protocol; crediting the entity for satisfied elements in a credit transcript based on the map; presenting the user the questions corresponding to unsatisfied elements and question data corresponding to the questions; allowing the user to navigate the questions and store responses in the credit transcript; automatically auditing the credit transcript to determine eligibility for at least one credential corresponding to the first protocol; generating a scorecard for the entity based on at least one of the credit transcript and the audit; and awarding at least one credential based on the scorecard.

### FIELD OF THE INVENTION

The present invention relates generally to automated technology for determining and verifiably tracking organizational compliance with standards such as International Standards Organization (ISO) standards and, more specifically, to systems and methods that facilitate determining, and verifiably tracking, compliance as the standards and entities using the standards evolve into wider ranges of compliance.

### BACKGROUND OF THE INVENTION

Internet and network connectivity have expanded rapidly to facilitate sharing information between organizations and users across the globe. Challenges to organizations arise from this freely available connectivity in a variety of ways. User information is increasingly valuable to organizations that have it. However, organizations must comply with a variety of regulatory standards that specify how the organization must collect, store and treat user information. Moreover, threats from hacking and other attempts to access valuable organizational and user information have led to additional regulatory compliance protocols and standards related to enhancing cyber security.

Many organizations have gone through a painstaking process of implementing and documenting tasks and procedures that are required to meet one or more compliance protocols associated with standards. As a result of this, an organization receives a compliance certificate for each compliance protocol with which the organization demonstrates compliance. There are many compliance protocols, including ISO and ANSI standards and protocols. Protocols also include those that address security and cyber security required for department of defense contractors and for protected health information used by medical care providers among others. Other examples of standards and compliance protocols include the CMMC, HIPAA and NIST protocols.

When organizations require a new, updated, or more stringent level of certification, they generally must meet new criteria that are specified in the standard. However, there is not an automatic or obvious way to credit organizations for baseline levels of compliance based on compliance with other standards or other certifications. It is seldom clear how much more work is required for additional certifications for standards, in a related series or standards, or between standards of different types.

There is a need for an automated system and method that allows organizations to self-certify or attest to standards compliance. There is a further need for an automated systems and method to allow an organization seeking compliance with new standards to obtain credit for being compliant with portions of other standards or certifications with which the organization is already compliant. There is a further need for certification credentials to be maintained in a current manner, so that organizations that may go in or out of compliance in real time and can be tracked in a verifiable manner.

### SUMMARY OF THE INVENTION

According to an embodiment of the present invention, systems and methods automatically process compliance protocols to enable automated compliance assessments using a compliance assessment application. A compliance engine automatically ingests compliance protocols as desired by a compliance administrator and beaks them down into their elemental requirements. Questions and related protocol information are generated for each element and stored by the protocol compliance engine as a schema to facilitate interviews. Certain elements may be stored with conditions for verifying real time requirements to maintain credentials, or levels of credentials, associated with each protocol. The compliance engine automatically generates maps that associate elements of a schema between each protocol and other protocols. Based on the maps, the credential engine generates a credit transcript that credits entities for elements of the first protocol that logically are related to elements of other protocol(s) with which the entity has credentials.

During automated interviews for compliance with a particular protocol, a compliance assessment application uses the element schema, map and compliance data associated with other protocols to guide automatically an entity through the creation of a credit transcript and compliance scorecard. The application further generates credentials or credential levels for the entity based on the responses, maps and other protocols with which the entity is compliant. The application may further adjust the credentials, or credential levels, based on real time conditions and real time elements associated with each protocol. In this manner, protocol schemas are generated and stored, and required elements interrelated between protocols, to facilitate automated and efficient self-assessment and credentialing, and thereafter real time monitoring where applicable.

According to one embodiment, a secure method of certifying compliance with a protocol to generate a verifiable and secure credential to access a trusted network, includes:

selecting a first protocol for which certification is requested on behalf of an entity;

generating a set of compliance questions for the first protocol corresponding to elements of at least one protocol including the first protocol;

identifying protocols other than the first protocol with which the user is currently certified;

mapping elements of the other protocols with elements of the first protocol;

crediting the entity for satisfied elements in a credit transcript based on the map;

presenting the user the questions corresponding to unsatisfied elements and question data corresponding to the questions;

allowing the user to navigate the questions and store responses in the credit transcript;

automatically auditing the credit transcript to determine eligibility for at least one credential corresponding to the first protocol;

generating a scorecard for the entity based on at least one of the credit transcript and the audit; and

awarding at least one credential based on the scorecard.

In some embodiments, the question data may include data corresponding to a description of the protocol and a link to related information. The scorecard may include data corresponding to different levels of certification and the at least one credential may be awarded based on the scorecard.

The method may further include:

determining real time data associated with the entity and the credential; and

awarding or revoking the at least one credential based on the real time data.

According to another embodiment of the invention, a method generates a set of elements for certifying compliance with a plurality of protocols having some common requirements and includes:

selecting a first protocol for certification;

automatically identifying elements corresponding to requirements of each paragraph of the protocol;

generating and storing a set of compliance questions associated with the elements;

automatically storing protocol data and links associated with each question;

processing the elements of the first protocol with elements of other protocols and based on the processing generating an element map relating the elements of the first protocol with similar elements of the other protocols;

storing the map in a compliance database;

automatically generating a transcript schema associated with the first protocol into which to store entity responses;

determining and storing in the transcript schema an elements that require real time monitoring;

automatically generating a scorecard relating potential responses and the map with scores and credentials for the first protocol; and

storing the transcript schmea and scorecard for the first protocol in the compliance database for use in interviewing entities to determine compliance with the first protocol.

### BRIEF DESCRIPTION OF THE FIGURES

The above described features and advantages of the present invention will be more fully appreciated with reference to the appended drawing figures described below.

FIG. 1 depicts a functional block diagram of a compliance assessment system and a compliance engine according to an embodiment of the invention.

FIG. 2 depicts a method of automatically processing requirements inherent in compliance protocols and making them efficiently available as mapped elements for compliance assessments according to an embodiment of the invention.

FIG. 3 depicts a functional block diagram highlighting the creation of elements from compliance protocol paragraphs according to an embodiment of the invention.

FIG. 4 depicts a functional block diagram highlighting the creation of elements and mapping across two compliance protocols according to an embodiment of the invention.

FIG. 5 depicts a process of automatically interviewing, crediting and scoring an entity on compliance with a selected protocol according to an embodiment of the invention.

FIG. 6 depicts a block diagram of a compliance processing system according to an embodiment of the invention.

FIG. 7 highlights illustrative data associated with compliance elements according to an embodiment of the present invention.

FIG. 8 depicts a functional block diagram of credentialing and real time verification according to an embodiment of the present invention.

### DETAILED DESCRIPTION

Many organizations have gone through a painstaking process of implementing and documenting tasks and procedures that are required to meet one or more compliance protocols associated with standards. As a result of this, an organization receives a compliance certificate for each compliance protocol with which the organization demonstrates compliance. There are many compliance protocols, including ISO and ANSI standards and protocols. Protocols also include those that address security and cyber security and for protected health information used by medical care providers, among others. There are many examples of compliance protocols including the Cybersecurity Maturity Model Certification (“CMMC”) for defense contractors, the Health Insurance Portability and Accountability Act (“HIPAA”) and protocols promulgated by the National Institutes of Science and Technology (“NIST”) on cyber security.

As described in more detail below, protocols with which compliance is sought by entities, such as corporations or individuals, according to the present invention may be automatically broken down into their elemental requirements. Questions and related protocol information are generated for each element and stored in a database for a protocol compliance engine to use as a schema to facilitate interviews. Certain elements may be stored with conditions for verifying real time requirements to maintain credentials, or levels of credentials, associated with each protocol. The compliance engine automatically generates maps that associate elements of a schema between a first protocol and other protocols. Based on the maps and the schema associated with respective compliance protocols, the credential engine generates a credit transcript that credits entities for elements of a protocol that logically are related to elements of other protocol(s) with which the entity has credentials.

During automated interviews for compliance with a particular protocol, a compliance assessment application uses the element schema, map and compliance data associated with other protocols to guide automatically an entity through the creation of a credit transcript and compliance scorecard. The application further generates credentials or credential levels for the entity based on the responses, maps and other protocols with which the entity is compliant. The application may further adjust the credentials or credential levels based on real time conditions and real time elements associated with each protocol. In this manner, protocol schemas are generated and stored and required elements interrelated between protocols to facilitate automated and efficient self-assessment and credentialing. Real time monitoring conditions may also be associated with elements where applicable.

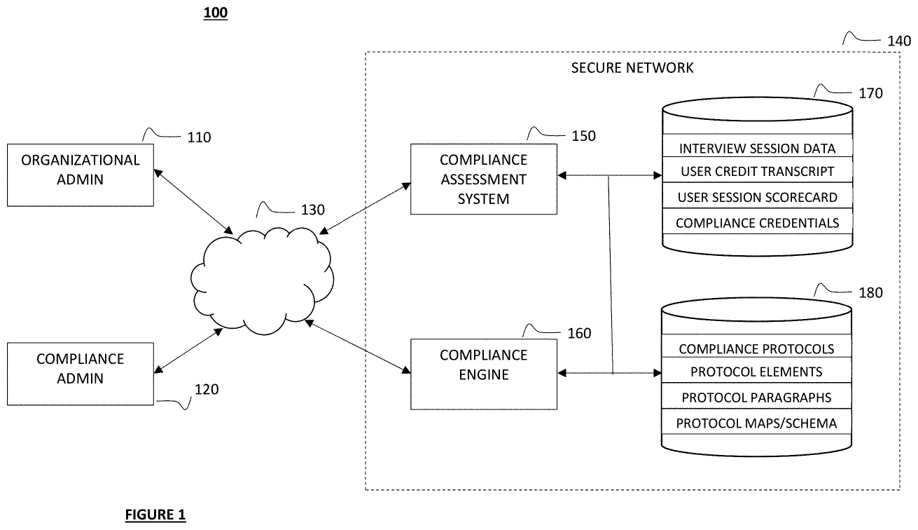

FIG. 1 depicts a functional block diagram of a compliance system 100 according to an embodiment of the present invention. Referring to FIG. 1, the system includes an organizational administrator 110 and a compliance administrator 120 at computers coupled via the Internet or other networks 130 to a secure network 140. The network 140 may include a compliance assessment system 150 coupled with a compliance engine 160, a compliance interview database 170 and a compliance protocol database (or compliance database) 180.

The compliance assessment system 150 may be a computer or server that executes program instructions to implement a compliance assessment application described herein. The Compliance assessment application accesses the compliance protocol database 180 to retrieve compliance protocols, protocol elements, protocol paragraphs and protocol maps and schemas for a compliance protocol selected by an organization. The compliance assessment system, through the application, generates an interactive session with the organizational administrator to automatically conduct an interview with the organization and store the results in the database 170, including interview session data, user credit transcript data, user session scorecard data and user compliance credentials.

The compliance engine 160 may be a computer or server that executes program instructions to generate elements from requirements embedded in paragraphs of certain compliance standards selected for support by the compliance engine, as explained in more detail below. The compliance engine parses the text of individual compliance protocol documents, and identifies paragraphs that contain requirements must be or can be met, to achieve a certification or a certification score or level. The paragraph requirements may be automatically processed using machine learning and/or rules to extract mandatory or and other requirements of the standard and reflect those requirements in questions that are associated with each element. There may be multiple elements for each paragraph. In addition, other compliance element data may be stored and associated with the data in protocol elements including protocol paragraphs, links to other information, helpful descriptions for administrators, scores, map data that relate the element in one protocol to elements in other protocols, and other schema. In general, the compliance engine interacts with the compliance database to read and create the compliance data shown in the database 180.

The organizational administrator 110 interacts with the secure network to access the network, to perform the compliance assessment provided by the compliance assessment application, and to certify compliance or otherwise obtain a compliance protocol credential. The secure network may be one that the organizational administrator is a member of that is highly secure. The secure network may also be a platform provider, cloud service provider or subscription service provider. The secure network may require that the organizational administrator or others within the organization have current credentials in order to access the system. Real time certification may be required, pursuant to which a real time condition associated with a protocol compliance element must be verified by the secure network in order for the compliance protocol credential to be valid.

The compliance administrator 120 interacts with the secure network to access the compliance engine 160 and to ensure that for each compliance protocol that may be set up by the system 100, the compliance protocol elements, maps/schema, descriptions and other element data that are generated are correct. The compliance administrator may also conduct audits on the user's credit transcript and scorecard to verify that elements are met and that the credentials or credential levels have been properly awarded.

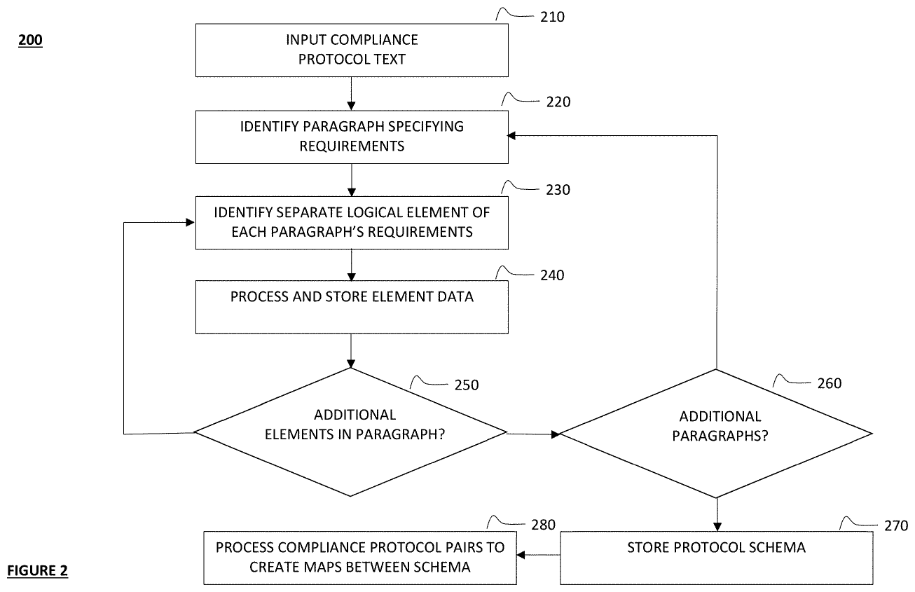

FIG. 2 depicts a method 200 of automatically processing requirements inherent in compliance protocols and making them efficiently available as mapped elements for compliance assessments according to an embodiment of the invention. Referring to FIG. 2, in step 210 a user, such as the compliance administrator, has selected a compliance protocol for processing and the compliance engine inputs the text of the selected compliance protocol for processing. In step 220, the compliance engine identifies paragraphs specifying requirements of the protocol. This may be done in a variety of ways, depending on the protocol document, including by machine learning through training the engine to recognize requirements by processing a corpus of prior exemplary standards whose requirements have been already been extracted from paragraphs. Alternatively, the text may be parsed for key words that signify logical requirements that must be met, including by words such as “should,” “shall,” or “must.” In 230, the compliance engine identifies the first logical element of a paragraph and in step 240 the compliance engine associates with the logical element, element data, such as a compliance question, protocol text, a description, a link, a score and other data as desired. The compliance engine may extract element data and questions directly from the compliance protocol by processing the text using machine learning as described above, or by extracting text surrounding mandatory elements and automatically formulating a question reflecting the text of the requirement. The compliance administrator may also edit the element data.

In 250, the compliance engine determines if there are additional required elements in the paragraph. If so, step 230 begins again. If not, in 260, the compliance engine determines whether or not there are additional paragraphs of the compliance protocol to process. If so, 220 begins again and the next paragraph of the compliance protocol is processed. If not, 270 begins. In 270, the compliance engine stores the protocol schema for the compliance protocol selected. In 280, the compliance engine compares the elements of the compliance standard just completed against other compliance protocols and creates a map of common elements between the schema. In this manner, the compliance engine relates elements in common between the standards such that when one element is satisfied for one standard it may be used to help satisfy the same or a similar element in another compliance protocol or standard.

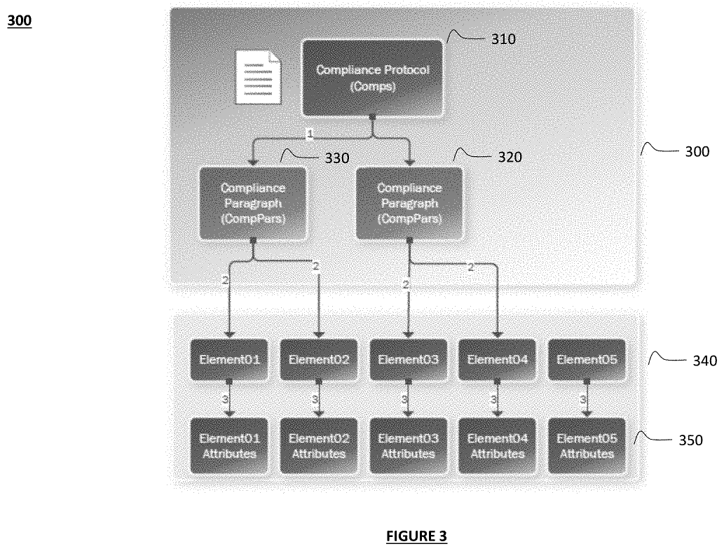

FIG. 3 depicts a functional block diagram 300 highlighting the creation of elements from compliance protocol paragraphs according to an embodiment of the invention. Referring to FIG. 3, the a compliance protocol, also sometimes referred to as a standard, comprises text, diagrams, links, videos, and/or other multi-media information associated with specifying what is required to be compliant with the compliance protocol. The compliance protocol has text broken into individual paragraphs, two of which are illustratively shown as paragraphs 320 and 330.

Paragraphs 320 and 330 each may be parsed as described above to determine separate logical compliance elements that are required. Each paragraph may have 0, 1, 2, or more than 2 requirements that are each reflected as elements 340. Each element in turn has attributes that are used by the compliance engine to facilitate certification of organizations through the compliance assessment application, including questions, descriptions, links, and other information. The element attributes 350, also referred to as element data, may also specify real time conditions that must be satisfied to achieve compliance. Element attributes may also specify a credential, a compliance or credential level, a compliance category or score. A simple example of questions associated with a protocol may be “Does your system require password?” or “Are passwords at least 6 characters long””, or “Do passwords expire every 3 months?”

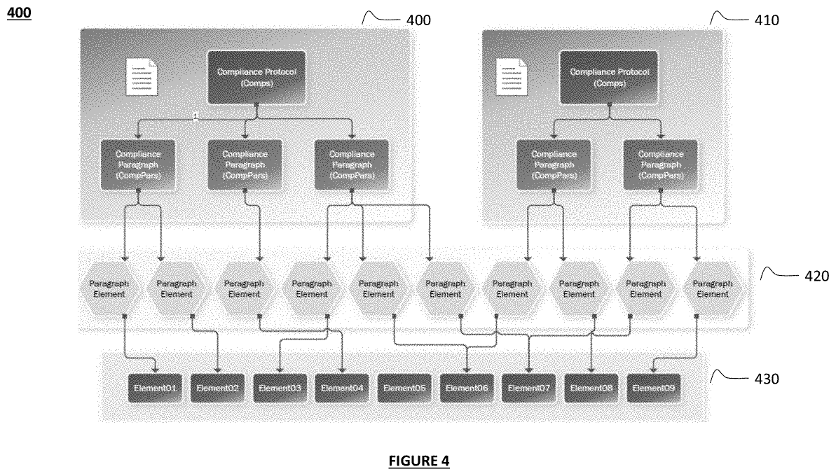

FIG. 4 depicts a functional block diagram 400 highlighting the creation of elements and mapping across two compliance protocols according to an embodiment of the invention. Referring to FIG. 400, each compliance protocol is broken down into paragraphs and each paragraph in turn is broken down into paragraph elements 420. Each paragraph element is associated with one of the pair of compliance protocols shown, and its paragraph attributes are associated with a schema applied to that compliance protocol. Some of the paragraph elements 420 are the same, or similar, between the compliance protocols 400 and 410. In these cases, the elements 430 identify collectively a map between paragraph elements of the respective compliance protocols 400 and 410 as shown. As a result, compliance with protocol 400 can result in compliance with elements 6 and 7 of compliance protocol 410, as shown. The compliance engine determines the mapping based on processing of text between the requirements of paragraph elements in the respective standards and the similarity of the requirements.

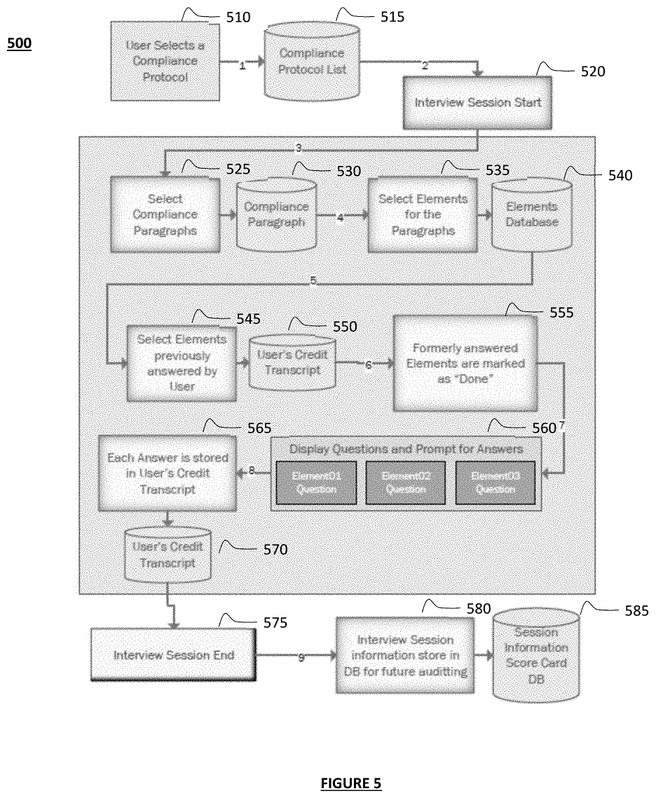

FIG. 5 depicts a process 500 of automatically interviewing, crediting and scoring an entity on compliance with a selected compliance protocol according to an embodiment of the invention. The process 500 is generally implemented through a graphical user interface (GUI) that is produced by the compliance assessment application program. This program presents to the user screens and interactive content that allows the user of the organizational administrator computer, or another computer, to specify a compliance protocol for certification. The program then interviews the user based on the elemental questions to allow the user to progress to certification.

Referring to FIG. 5, in 510, the user selects a compliance protocol from the available protocols in the database 515. In 520, an automated interview session is begun between the compliance assessment application and the user. In 525, the compliance application selects compliance paragraphs 530 from the compliance database 180 that remain to be addressed in the interview. In 535, elements for the selected paragraphs are selected from the corresponding elements in the database 540. In 545, the previous elements answered by the user are bypassed as these are stored in the user's credit transcript 550. Formerly answered questions are marked done in 555. This can occur when a user has answered questions for an element in a current session, or in a previous session, with the same compliance protocol. Elements can also be marked done when the user or organization has previously complied with another compliance protocol that has the same or a similar element. In 560, remaining element questions are interactively presented to the user through the GUI. In 565 and 570, each user answer is stored in the user's credit transcript.

In 575, the interview session is ended by the user or the application. The session may end because the user has finished answering all of the questions in the interview. Alternatively, the user may end the session prior to completing all of the questions, and the automated application will pick back up where the user left off and go through, interactively, the remaining questions with the user. In 580, an interview session, including a completed session, is stored in the database for auditing compliance by the compliance administrator. Session information for completed and incomplete sessions may be stored as a scorecard in the database 585.

Some compliance protocols may not only provide for a single credential on certification, but may provide certification at different levels. The scorecard may comprise data associated with the answers to each question and a score or a category data for each answer. The scorecard may then be read by the compliance engine and/or the application to determine the level of the user's compliance based on the score or category data associated with the user's answers.

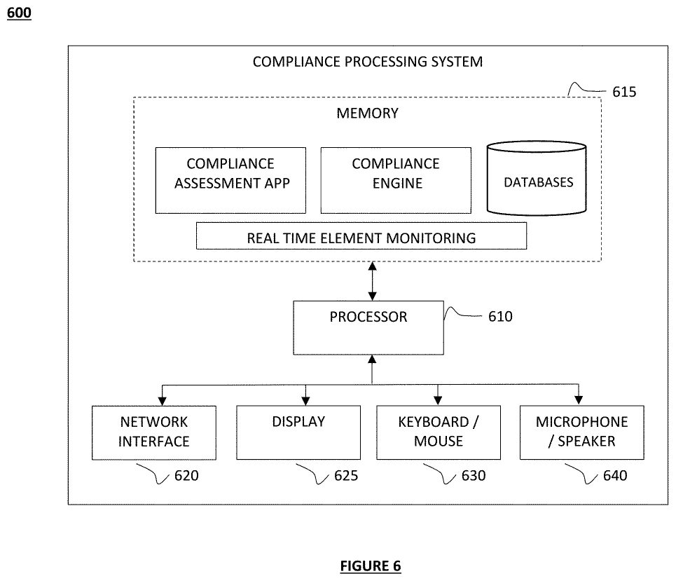

FIG. 6 depicts a block diagram of a compliance processing system according to an embodiment of the invention. Referring to FIG. 6, a compliance processing system 600 includes a processor 610, coupled to a memory 615, a network interface 620, a display 625, input/output devices such as a keyboard and mouse 630, and microphone/speaker 640. The memory stores program instructions that, when executed by the computer 600, cause the computer to perform the compliance assessment application and the methods of the compliance engine. These programs also cause the computer to access the databases according to the methods and processes described herein. The memory may further include a real time monitoring program that monitors conditions that may be specified for some elements of compliance. The compliance administrator and the organizational administrator may use a computer 600. The computer 600 may be a server that the administrators access via a network. The network interface communicates via the internet and other networks with other computers and devices, wirelessly, electrically, optically, or in any other known manner.

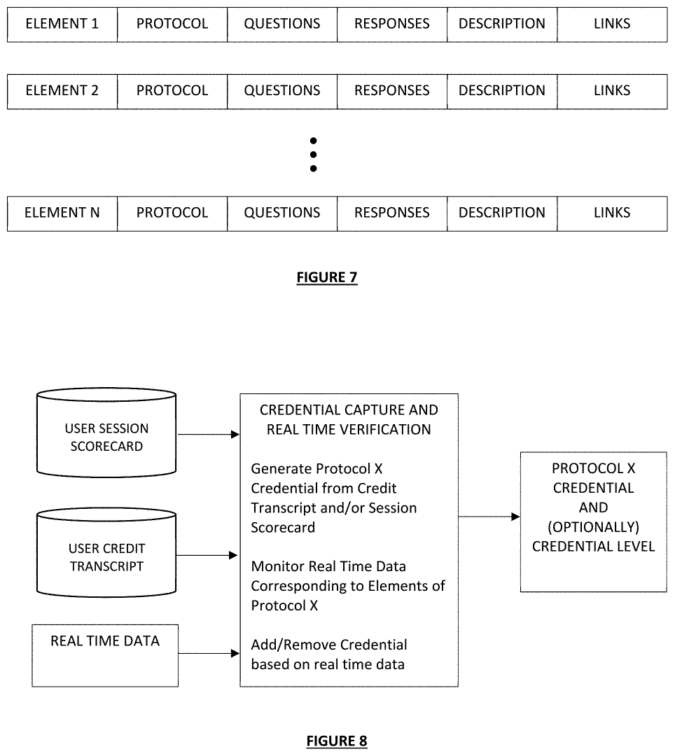

FIG. 7 highlights illustrative data associated with compliance elements according to an embodiment of the present invention. Referring to FIG. 7, element attributes are shown for an illustrative set of attributes. A schema for each compliance protocol may specify the attributes and database organization for attributes associated with each element. For example, as shown, each element in a schema may include a protocol identification, questions, responses, a description to facilitate an interview on the questions and links for additional information. Any other information may be stored as attributes or element data associated with each element.

There may be N elements associated with each compliance protocol as shown. In addition, the compliance engine may administer multiple compliance protocols, each with its own schema. Alternatively, the schema may be the same for some of the compliance protocols. The map described herein creates correlations between common elements of different compliance protocols, and the correlations may be stored as attribute data associated with each element or as separate map data in the compliance database.

FIG. 8 depicts a functional block diagram of credentialing and real time verification, according to an embodiment of the present invention. Referring to FIG. 8, a user session scorecard, a user credit transcript, and real time data are shown as inputs to a process. The process generates a credential for a protocol based on the credit transcript and/or the session scorecard. The credential can be generated: (i) when the transcript reflects completion of all elements; (ii) when the scorecard reflects completion of all elements; or (iii) when the transcript and the scorecard reflect completion of all elements. The scorecard may capture a successful audit result, which may be a prerequisite for final credentialing if required. In addition, data in the scorecard, including scores or categories associated with answers, may be used or tallied according to a schema for the standard to determine a compliance level for the credential.

In addition, when one or more elements contain real time conditions that need to be satisfied for a credential to be verified, the process, which may run on the compliance engine or otherwise as part of the secure network, may determine whether the compliance conditions are met in real time. If so, the credential is active. If not, the credential may temporarily deactivated on the secure network. The process shown may output the credential for use by the secure network.

While particular features of the invention have been shown and described herein, it will be understood by those having ordinary skill in the art, that changes may be made to those embodiments without departing from the spirit and scope of the invention.

What is claimed is:

1. A secure method of certifying compliance with a protocol to generate a verifiable and secure credential to access a trusted network, comprising:
selecting a first protocol for which certification is requested on behalf of an entity;
generating a set of compliance questions for the first protocol corresponding to elements of at least one protocol including the first protocol;
identifying protocols other than the first protocol with which the user is currently certified;
mapping elements of the other protocols with elements of the first protocol;
crediting the entity for satisfied elements in a credit transcript based on the map;
presenting the user the questions corresponding to unsatisfied elements and question data corresponding to the questions;
allowing the user to navigate the questions and store responses in the credit transcript;
automatically auditing the credit transcript to determine eligibility for at least one credential corresponding to the first protocol;
generating a scorecard for the entity based on at least one of the credit transcript and the audit; and
awarding at least one credential based on the scorecard.

2. The secure method according to claim 1, wherein the question data includes data corresponding to a description of the protocol and a link to related information.

3. The secure method according to claim 2, wherein the scorecard includes data corresponding to different levels of certification and the at least one credential is awarded based on the scorecard.

4. The secure method according to claim 1, further comprising:
determining real time data associated with the entity and the credential; and
awarding or revoking the at least one credential based on the real time data.

5. The secure method according to claim 4, wherein the awarding or revoking the at least one credential results in a change in credential level associated with the first protocol.

6. The secure method according to claim 4, wherein the credit transcript, scorecard and at least one awarded credential are stored on a trusted network with which the entity is an authorized member.

7. A method of generating a set of elements for certifying compliance with a plurality of protocols having some common requirements to generate a verifiable and secure credential to access a trusted network, comprising:
selecting a first protocol for certification;
automatically identifying elements corresponding to requirements of each paragraph of the protocol;
generating and storing a set of compliance questions associated with the elements;
automatically storing protocol data and links associated with each question;
processing the elements of the first protocol with elements of other protocols and based on the processing generating an element map relating the elements of the first protocol with similar elements of the other protocols;
storing the map in a compliance database;
automatically generating a transcript schema associated with the first protocol into which to store entity responses;
determining and storing in the transcript schema an elements that require real time monitoring;
automatically generating a scorecard relating potential responses and the map with scores and credentials for the first protocol; and
storing the transcript schmea and scorecard for the first protocol in the compliance database for use in interviewing entities to determine compliance with the first protocol.
